(19) United States
(12) Patent Application Publication
(10) Pub. No.: US 2024/0368919 A1
(43) Pub. Date: Nov. 7, 2024

(54) FLAT KEY COMPRISING SURFACE CODING AND A CYLINDER LOCK

(71) Applicant: EVVA Sicherheitstechnologie GmbH, Vienna (AT)

(72) Inventors: Michael RIESEL, Weida (DE); Florian OBERLEITNER- LEEB, Wien (AT); Markus OTTERSBÖCK, Neuhaus (AT)

(73) Assignee: EVVA Sicherheitstechnologie GmbH, Vienna (AT)

(21) Appl. No.: 18/567,946

(22) PCT Filed: Jun. 8, 2022
(86) PCT No.: PCT/AT2022/060192

§ 371 Date: Dec. 7, 2023

(30) Foreign Application Priority Data
Jun. 9, 2021 (AT) A50467/2021

(51) Int. Cl. E05B 19/00; E05B 27/00

(52) U.S. Cl. CPC E05B 19/0011; E05B 27/0042; E05B 19/0058

(57) ABSTRACT

The invention relates to a flat key (1) for a cylinder lock (11), said flat key comprising: a key bow (2) and a key shaft (3) that extends substantially parallel to a key longitudinal axis (L) and has a key tip (4), wherein at least one surface coding (6) designed to be read in the cylinder lock (11) is located at the end face (5) of the key tip (4); and a cylinder lock (11) for receiving such a flat key (1), and a locking system comprising one or more such flat keys (1) in combination with one or more such cylinder locks (11).

The invention relates to a flat key with a surface code and a cylinder lock for receiving such flat key

In the prior art, flat keys with a key bow and a key shank extending along a longitudinal axis with a key tip are known, in which codes are arranged in the region of the key tip. For example, DE 20 2016 105 750 U1 shows a flat key and a corresponding cylinder lock, wherein the flat key is designed with a torsion-shaped twist in the region of the key tip, and profile elements for coding are arranged in the torsion section of the key tip. A coupling element is provided in the matching cylinder lock which scans these profile elements at the key tip.

One problem with such designs, however, is that modern high-resolution cameras and suitably equipped copying machines can copy even torsionally twisted profile elements in the area of the key tip, enabling unauthorised key copies to be made.

One object of the present invention is to solve this problem and to create a flat key and a matching cylinder lock which is as difficult as possible to copy, yet can be easily manufactured and offers additional variation possibilities for coding.

These and other objects are solved according to the invention with a flat key according to claim 1 and a cylinder lock according to claim 18.

A flat key for a cylinder lock according to the invention comprises a key bow and a key shank extending substantially parallel to a longitudinal axis L of the key. The longitudinal axis L of the key is substantially parallel to the direction of insertion of the key into an associated cylinder lock. In particular, the longitudinal axis L of the key may coincide with the axis of rotation D of the cylinder core in an associated cylinder lock. The key shank has a key tip, wherein at least one surface code is arranged on the end face of the key tip. The surface code is designed in such a way that it can be scanned in a suitable cylinder lock.

The surface code may have a substantially non-linear course at least partially along a spatial axis x, y or z of a Cartesian coordinate system. A cross-section of the surface code along one of these spatial axes would thus have a non-linear course, for example in the form of a one-dimensional sinusoidal code of the key tip.

The surface code may also have a substantially non-linear course at least partially along two spatial axes x and y, y and z, or x and z of a Cartesian coordinate system. Cross-sections of the surface code along two orthogonal spatial axes would thus have a non-linear course, for example in the form of a two-dimensional sinusoidal coding of the key tip.

Optionally, the surface code may also have a substantially non-linear course at least partially along all three spatial axes x, y and z of a Cartesian coordinate system. Cross-sections of the surface code would thus have a non-linear course at least partially along all three orthogonal spatial axes. This could be achieved, for example, by integrating spherical coding elements in sections into the surface code.

The surface code may also have linear and non-linear parts. For example, a portion of 10% to 90%, optionally 30% to 70%, in particular 50%, of the surface code may be linear, and the remaining portion may be non-linear in one of the ways described above.

In relation to the surface of the end face of the flat key, the surface coding may run over part of the end face or over the entire end face. Preferably, a part of 10% to 90%, possibly also 30% to 70%, in particular 50%, of the end face may be covered by the surface code.

By arranging the surface code on the end face of the key tip, the production of photographic images is significantly more difficult than with conventional codes on the side faces. In addition, conventional tools are usually not able to create surface codes on the end face of the key tip. This results in a technical copy protection of a key according to the invention. Furthermore, the different design of the surface code with regard to its position and angle allows further variation possibilities for corresponding key-lock combinations.

According to the invention, it may be provided that at least one first surface code for interrogation in the cylinder lock is arranged on the end face of the key tip, and at least one second surface code for interrogation in the cylinder lock is arranged on the end face of the key tip. The surface codes may be substantially congruent and rotated by an angle of about 180° with respect to the longitudinal axis L of the key, so that the flat key can also be used as a reversible key.

According to the invention, it may be provided that the surface codes are predominantly or exclusively arranged on the end face of the key tip. In other words, the surface codes may also extend from the end face to one or more side surfaces, but they are predominantly located on the end face, so that dedicated scanning of the end face must take place in the cylinder lock.

According to the invention, it may be provided that the surface codes are shaped in the form of recesses with scanning surfaces on the end face of the key tip, wherein the scanning surfaces correspond at least partially to the circumferential surfaces of a rotational body with a rotational axis R and are preferably shaped as millings. Such a recess may have a complex three-dimensional shape. The ideal rotation body may in particular be the tool for forming the surface codes. However, this tool is not part of a flat key according to the invention.

It may be provided that the rotational body has an analytically describable cross-sectional geometry in one, two or all three spatial axes.

In particular, it may be provided that the rotational body is substantially a sphere, cylinder, cone, truncated cone or ellipsoid with a rotational axis R. According to the invention, it may be provided that the rotational axis R is inclined at an angle to the longitudinal axis L of the key, the angle being about 45° to 90°, preferably about 75°. The inclination may be such that the recess tapers in the direction of the key bow towards the key tip.

According to the invention, it may be provided that the axis of rotation R is inclined at an angle to a transverse plane E of the flat key, the angle being about 45° to 90°, preferably about 85°. The inclination may be directed outwards from the longitudinal axis L of the key, so that the recess tapers in the direction from the side surface to the longitudinal axis L of the key.

According to the invention, it may be provided that the rotational axis R is arranged substantially along a transverse plane E of the flat key offset from the longitudinal axis L of the key by a distance, the distance preferably being about 1/10 to about ¼ of the width of the key shank.

All these configurations of the rotational axis may be used in a locking system according to the invention to create key variations.

According to the invention, it may be provided that the surface codes overlap in sections, preferably in the region of the longitudinal axis of the key. In particular, it may be provided that a preferably spatially curved, for example S-shaped, contour line is formed on the end face of the key tip between the surface codes. The contour line may also be formed by the intersection of the surface codes.

According to the invention, it may be provided that at least one additional code with a further scanning surface is provided on the end face of the key tip, the shape of which may differ from the scanning surface of the surface code. The additional code may run over part of the end face. Preferably, a part of 10% to 90%, possibly also 30% to 70%, in particular 50%, of the end face may be covered by the additional code. According to the invention, it may be provided that the additional code at least partially overlaps the surface code.

Like the surface code, the additional code may also have a substantially non-linear course at least partially along one, two or three spatial axes. The additional code may also have a scanning surface that corresponds at least partially to the circumferential surface of an ideal rotational body and may preferably be designed as a milling. According to the invention, it may in particular be provided that the additional code is of a torsional shape.

According to the invention, it may be provided that at least one first surface code and at least one first additional code for interrogation in the cylinder lock are arranged on the end face of the key tip, and at least one second surface code and at least one second additional code for interrogation in the cylinder lock are arranged on the end face of the key tip.

It may be provided that both the surface codes and the additional codes are substantially congruent with each other and rotated by an angle of about 180° with respect to the longitudinal axis of the key, so that the flat key can also be used as a reversible key.

The invention also relates to a cylinder lock with a key channel for receiving a flat key, which is designed to scan the surface code and optionally also the additional code of the flat key. According to the invention, it may be provided that such a cylinder lock comprises an optionally multi-component coupling assembly which is rotatable about the axis of rotation D of the cylinder core and a locking nose.

According to the invention, it may be provided that the cylinder lock is designed to transmit a rotation of the cylinder core about the axis of rotation D to the locking nose upon insertion of an authorised flat key. In particular, it may be provided that the coupling assembly is designed to transmit a rotation of the cylinder core about the axis of rotation D to the locking nose upon insertion of an authorised flat key.

For this purpose, the coupling assembly may be displaceable in the longitudinal direction, preferably linearly, along the axis of rotation D, and may be positively connected to the locking nose in a release position (lock may be actuated), whereas it may not be connected to the locking nose in a locked position (lock cannot be actuated). The release position and locked position differ in the longitudinal position of the coupling assembly along the axis of rotation D.

According to the invention, it may be provided that the coupling assembly is designed for positive engagement with the surface codes and, optionally, also with the additional codes on the end face of the flat key. Thus, an authorised key may immediately move the coupling assembly from the locked position to the release position by longitudinal displacement.

According to the invention, however, it may also be provided that an adapter is provided between the cylinder core and the coupling assembly, which adapter is displaceable substantially along, or parallel to, the axis of rotation D, the adapter having a contour on the side facing away from the key channel for engagement in the coupling assembly. The adapter engages with the codes on the key tip and is displaced by an authorised key in such a way that it in turn moves the coupling into the release position, thus enabling a positive connection between the cylinder core and the locking nose. In the case of an unauthorised key, the adapter does not fully engage the codes so that the coupling assembly remains in the locked position and a positive connection between the cylinder core and the locking nose may not be created.

According to the invention, it may be provided that the adapter comprises at least one scanning element for engagement with the surface code, wherein the surface shape of the scanning element preferably corresponds to the scanning surface of the surface code. The shape of the scanning element may at least partially correspond to that of the rotational body that was used to create the surface or additional code.

According to the invention, it may be provided that the adapter has a plurality of scanning elements for engaging the surface codes and, optionally, additional codes on the end face of the flat key, the surface shape of the scanning elements preferably corresponding to the scanning surfaces of the surface codes and, optionally, of the additional codes.

The invention further relates to a locking system comprising one or more flat keys according to the invention and one or more cylinder locks according to the invention.

Further features according to the invention optionally emerge from the claims, the description of the exemplary embodiments, and the figures.

The invention is now further explained on the basis of non-exclusive and non-limiting exemplary embodiments.

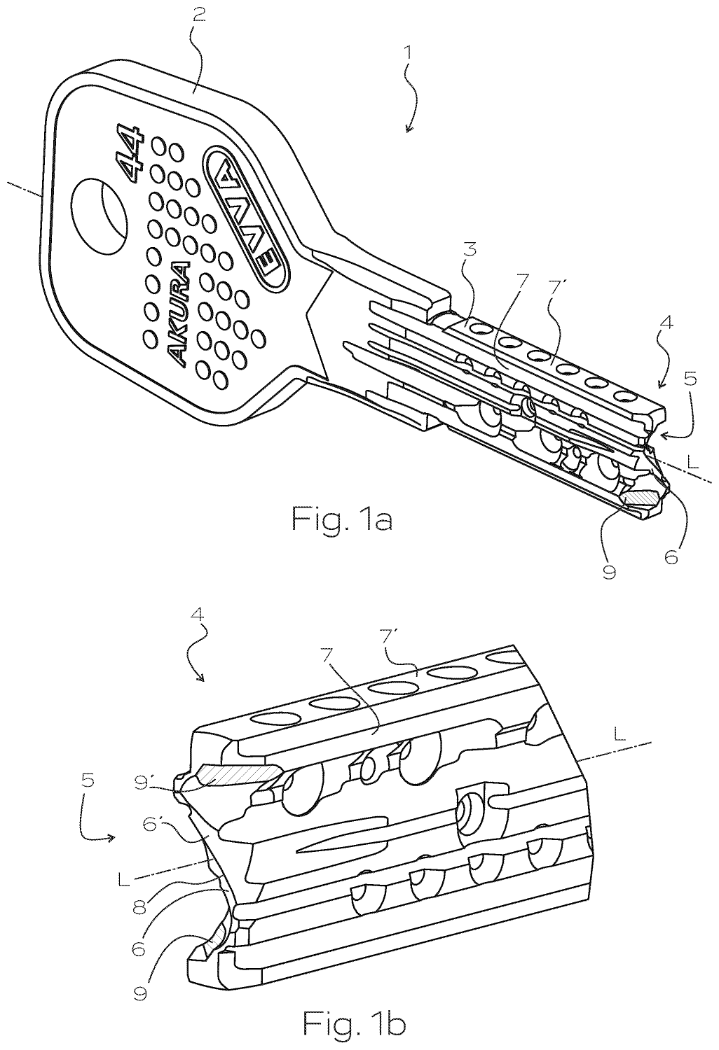

FIGS. 1a-1b show an embodiment of a flat key according to the invention in a schematic three-dimensional representation;

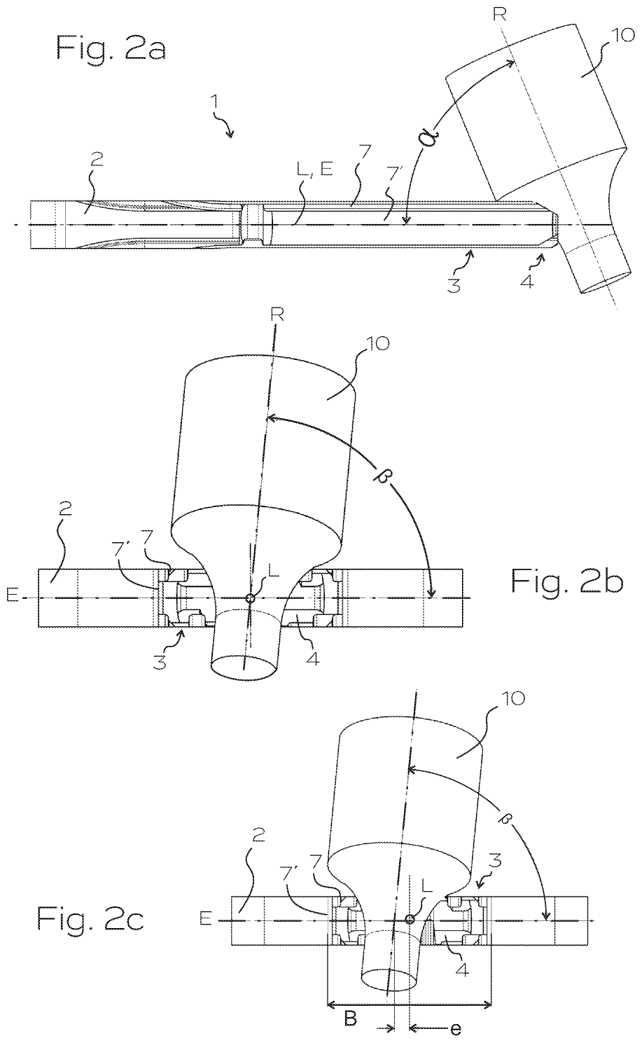

FIGS. 2a-2c show this embodiment in schematic view from above and from the front as well as a rotational body with analytically describable cross-section;

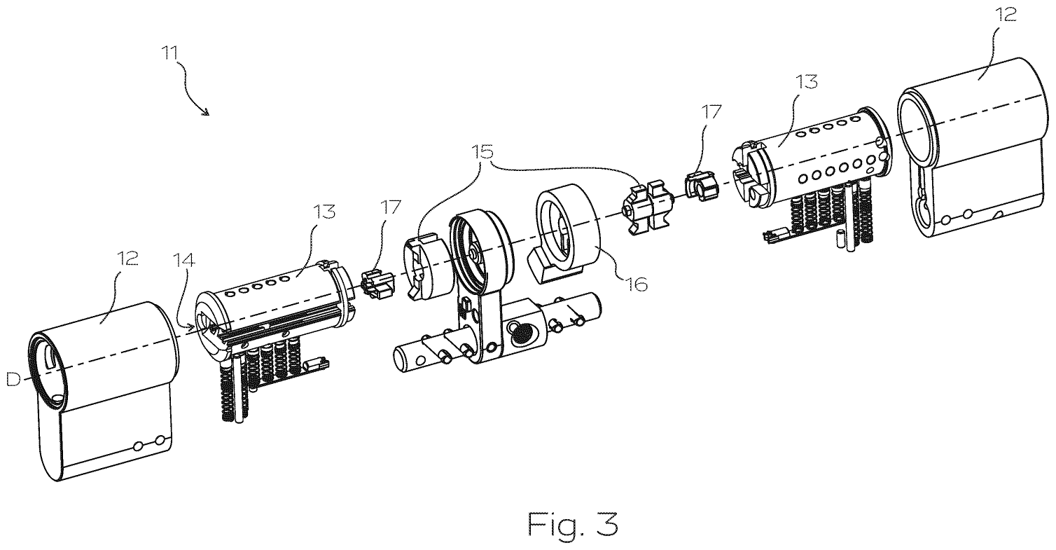

FIG. 3 shows an embodiment of a cylinder lock according to the invention in an exploded view;

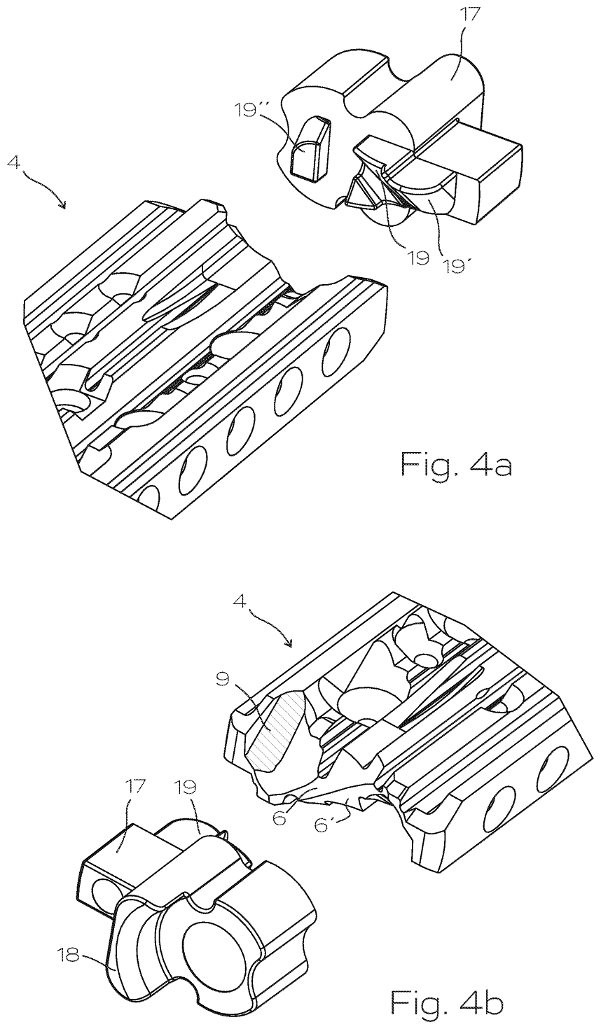

FIGS. 4a-4b show schematic three-dimensional representations of the interaction of a flat key according to the invention with a cylinder lock according to the invention;

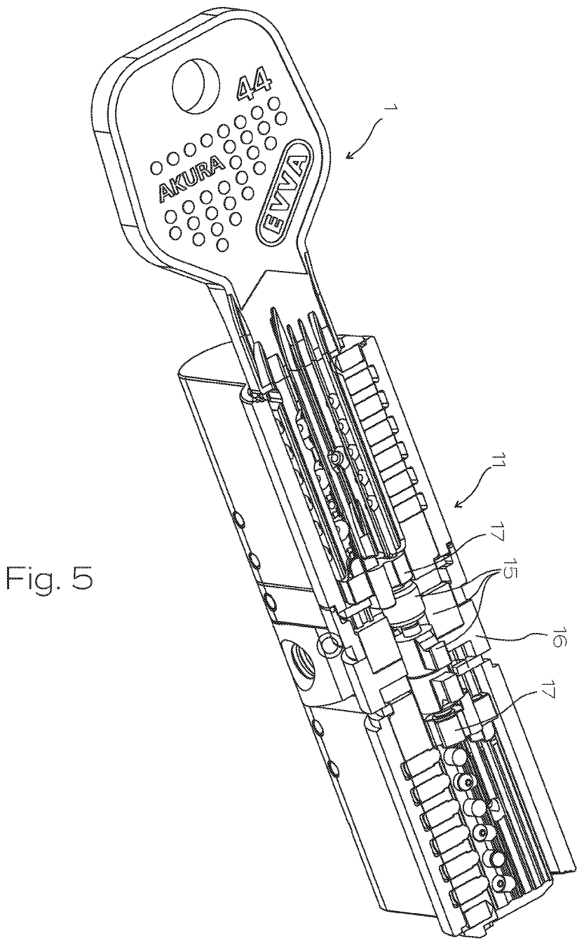

FIG. 5 shows an embodiment of a locking system according to the invention with a flat key according to the invention and a cylinder lock according to the invention.

FIG. 1a shows an embodiment of a flat key according to the invention 1 in a schematic three-dimensional representation. The flat key 1 is conventionally provided with a key bow 2 and a key shank 3 extending along a longitudinal axis L of the key. In this exemplary embodiment, the key shank 3 has a substantially rectangular cross-section with four side surfaces, namely two wide side surfaces 7 and two narrow side surfaces 7′. Various profiling lines and codes are arranged on the side surfaces 7, 7′.

Two surface codes 6, 6′ and two additional codes 9, 9′ are arranged on the key tip 4, each of which has three-dimensionally shaped scanning surfaces for interrogation in the cylinder lock. These scanning surfaces extend from the end face 5 of the key tip 4 to the side surfaces 7, but for the most part run orthogonally to the side surfaces 7, so that their concrete three-dimensional shape can only be determined in each case by scanning from the end face 5.

FIG. 1b shows the key tip 4 in an enlarged view. Here it becomes evident that a first surface code 6 and a second surface code 6′ are arranged on the end face 5 of the key tip 4, wherein the surface codes 6,6′ are substantially congruent and are rotated by an angle of approximately 180° with respect to the longitudinal axis L of the key. This ensures that the flat key 1 can be used as a reversible key. The concrete shape of the scanning surfaces in this exemplary embodiment is therefore substantially rotationally symmetrical to the longitudinal axis L of the key.

Furthermore, it is evident in this detailed representation that further additional codes 9, 9′ are provided on the end face 5, which also have scanning surfaces, but which differ from those of the surface codes 6, 6′. In the present exemplary embodiment, the additional codes 9, 9′ partially overlap the respective surface codes 6, 6′. This creates a further variation possibility, since in the appropriate cylinder lock not only the scanning surface of the surface code 6, 6′, but also the scanning surface of the additional code 9, 9′ must be scanned correctly.

A spatially curved and substantially S-shaped contour line 8 runs between the surface codes 6, 6′. This is formed by milling the key blank when producing the surface codes 6, 6′ and/or the additional codes 9, 9′. The shape and slope of the contour line 8 may also be scanned in the cylinder lock and thus used to form key variations.

FIG. 2a schematically shows the situation during the production of a surface code 6 in a view of the key 1 from above. In this exemplary embodiment, the surface coding 6 is formed in the form of a recess on the end face 5 of the key tip 4. The recess has a scanning surface which substantially corresponds to the circumferential surface of a rotational body 10. In practice, this may be achieved by a suitably designed milling tool, as shown schematically in this figure. However, the surface code 6 does not necessarily have to be produced as a milling.

The rotational axis R of the rotational body 10 is shown schematically. It is shown that the rotational axis R is inclined from the key tip 4 towards the key bow 2 at an angle of about 75° to the longitudinal axis L of the key. This representation also shows the transverse plane E of the flat key 1.

FIG. 2b schematically shows the situation during the production of a surface code 6 in a view of the key 1 from the front. Here, the end face 5 of the flat key 1 is directly visible. In this representation, the longitudinal axis L of the key runs in the plane of the drawing and orthogonally to the transverse plane E of the flat key 1. The rotational body 10 is inclined at an angle of about 85° with respect to the transverse plane E to form the surface code 6.

FIG. 2c schematically shows the situation during the production of another embodiment of a surface code 6 in a view of the key 1 from the front. Here, the end face 5 of the flat key 1 is again directly visible. In this illustration, the longitudinal axis L of the key runs in the plane of the drawing and orthogonally to the transverse plane E of the flat key 1. The rotational body 10 is inclined at an angle of about 85° with respect to the transverse plane E to form the surface code 6.

Furthermore, in this embodiment the rotational axis R is arranged along the transverse plane E of the flat key 1 offset by a distance e from the longitudinal axis L of the key. In the exemplary embodiment example shown, the distance e is about ⅕ of the total width B of the key shank 3. In other words, the rotational axis R runs eccentrically to the longitudinal axis L of the flat key 1.

FIG. 3 shows an embodiment of a cylinder lock 11 according to the invention in an exploded view. The cylinder lock 11 comprises a cylinder core 13 rotatable about an axis of rotation D in a cylinder housing 12 with a key channel 14 for receiving a flat key 1. The cylinder lock 11 is designed to be locked from two sides, so that two cylinder cores 13 and two cylinder housings 12 are provided. The cylinder lock 11 is designed to allow locking only when a suitable flat key 1 is inserted in one of the two key channels 14.

The cylinder lock 11 further comprises a coupling assembly 15 rotatable about the axis of rotation D and a locking nose 16. The coupling assembly 15 is adapted to transmit the rotation of the cylinder core 13 to the locking nose 16 when an authorised flat key 1 is inserted into the key channel 14.

In the exemplary embodiment shown here, an adapter 17 is provided between the cylinder core 13 and the coupling assembly 15, which is displaceable along the axis of rotation D. The adapter 17 is designed to shift the position of the coupling assembly 15 when the flat key 1 is inserted, in such a way that when an authorised flat key 1 is inserted, a positive connection is established between the cylinder core 13, the coupling assembly 15 and the locking nose 16. On its side facing the key channel 14, the adapter 17 has a plurality of scanning elements 19, 19′, 19″ for engaging the surface codes 6, 6′ and additional codes 9, 9′ on the end face 5 of the flat key 1. The exact positioning of the coupling assembly 15 along the axis of rotation D for positive transmission of the rotation thus only occurs if the scanning elements 19, 19′, 19″ on the adapter 17 largely correspond to the negative shape of the surface codes 6, 6′ and additional codes 9, 9′.

It may be provided that the coupling assembly 15 is biased along the axis of rotation D by a spiral spring (not shown) to ensure the locked state when the flat key 1 is removed from the key channel 14.

In an exemplary embodiment not shown, the coupling assembly 15 is designed directly for positive engagement with the surface codes 6, 6′ and, optionally, also with the recesses 9, 9′ on the end face 5 of the flat key 1. For this purpose, the coupling assembly has projections designed to scan the surface codes 6, 6′ and optionally also the recesses 9, 9′ on the face 5 of the flat key 1.

When an authorised flat key 1 is inserted into the key channel 14, the coupling assembly 15 is immediately moved into the correct longitudinal position along the axis of rotation D by the codes on the end face 5 of the flat key 1, so that the release state is achieved.

FIGS. 4a-4b show this described interaction of the adapter 17 with the key tip 4 schematically by means of three-dimensional representations of a flat key 1 according to the invention and the adapter 17. The adapter 17 has three scanning elements 19, 19′, 19″ designed to scan the surface code 6 and the additional code 9 on the end face 5 of the key tip 4 of a flat key 1. If the scanning elements fit the codes, the adapter 17 is displaced along the axis of rotation D in such a way that it in turn transmits a rotation of the cylinder core 13 to the locking nose 16 in a positive manner via the contour 18 on the side facing away from the flat key 1 by actuating the coupling assembly 15, and the cylinder lock 11 can thus be actuated.

FIG. 5 shows an embodiment of a locking system according to the invention with a flat key 1 according to the invention and a cylinder lock 11 according to the invention. Again, the interaction of the key tip 4 with the adapter 17 and the multi-component coupling assembly 15 and the locking nose 16 is shown.

The invention is not limited to the illustrated embodiments, but rather comprises any flat keys/cylinder locks or locking system according to the following patent claims. In particular, the terms milling or incision milling, where used, are not intended to be limited to recesses formed by means of a milling tool, but to include recesses formed by any means.

### LIST OF REFERENCE SIGNS

1 Flat key
2 Key bow
3 Key shank
4 Key tip
5 End face
6, 6′ Surface code
7, 7′ Key lateral surface
8 Contour line
9, 9′ Additional code
10 Rotational body
11 Cylinder lock
12 Cylinder housing
13 Cylinder core
14 Key channel
15 Coupling assembly
16 Locking nose
17 Adapter
18 Contour
19, 19′ Scanning element
B Width of the key shank
D Axis of rotation of the cylinder core and the coupling assembly
E Transverse plane of the flat key
L Longitudinal axis of the key
R Rotational axis
E Eccentricity of the rotational axis to L
α Tilt angle of R to L
β Tilt angle of R to E

1. A flat key for a cylinder lock, comprising a key bow and a key shank extending substantially parallel to a longitudinal axis of the key and having a key tip, characterised in that at least one surface code formed for interrogation in the cylinder lock is arranged on the end face of the key tip.

2. The flat key according to claim 1, wherein the surface code has a substantially non-linear course at least partially along a spatial axis x, y or z.

3. The flat key according to claim 2, wherein the surface code has a substantially non-linear course at least partially along two spatial axes x and y, y and z, or x and z.

4. The flat key according to claim 3, wherein in the surface code has a substantially non-linear course at least partially along all three spatial axes x, y and z.

5. The flat key according claim 1, wherein
a. at least one first surface code is arranged on the end face of the key tip for interrogation in the cylinder lock, and
b. at least one second surface code is arranged on the end face of the key tip for interrogation in the cylinder lock, wherein
c. at least the surface codes are substantially congruent and rotated by an angle of approximately 180° with respect to the longitudinal axis of the key, so that the flat key can also be used as a reversible key.

6. The flat key according to claim 1, wherein the surface codes run for the most part, in particular exclusively, on the end face of the key tip.

7. The flat key according to claim 1, wherein the surface codes are shaped in the form of recesses with scanning surfaces on the end face of the key tip, the scanning surfaces corresponding substantially to the circumferential surfaces of a rotational body with a rotational axis and preferably being shaped as millings.

8. The flat key according to claim 7, wherein the rotational body has an analytically describable cross-sectional geometry in one, two or all three spatial axes.

9. The flat key according to claim 7, wherein the rotational body is substantially a sphere, a cylinder, a cone, a truncated cone or an ellipsoid.

10. The flat key according to claim 7, wherein the rotational axis is inclined at an angle α to the longitudinal axis of the key, the angle α being about 45° to 90°, preferably about 75°.

11. The flat key according to claim 7, wherein the rotational axis is inclined at an angle α to a transverse plane of the flat key, the angle α being about 45° to 90°, preferably about 85°.

12. The flat key according to claim 7, wherein the rotational axis is arranged substantially along a transverse plane of the flat key offset by a distance from the longitudinal axis of the key, the distance preferably being about 1/10 to about ¼ of the width of the key shank.

13. The flat key according to claim 5, wherein the surface codes overlap in sections, preferably in the region of the longitudinal axis of the key.

14. The flat key according to claim 5, wherein a preferably spatially curved, for example S-shaped, contour line is formed on the end face of the key tip between the surface codes.

15. The flat key according to claim 1, wherein at least one additional code with a further scanning surface is provided on the end face of the key tip, the shape of which may differ from the scanning surface of the surface code.

16. The flat key according to claim 15, wherein at the additional code at least partially overlaps the surface code.

17. The flat key according to claim 15, wherein
a. at least one first surface code and at least one first additional code are arranged on the end face of the key tip for interrogation in the cylinder lock, and
b. at least one second surface code and at least one second additional code are arranged on the end face of the key tip for interrogation in the cylinder lock, wherein
c. at least the surface codes, and preferably also the additional codes, are in each case substantially congruent with one another and are rotated through an angle of approximately 180° with respect to the longitudinal axis of the key, so that the flat key can also be used as a reversible key.

18. A cylinder lock comprising a cylinder core rotatable in a cylinder housing about an axis of rotation and having a key channel for receiving a flat key according to claim 1, characterised in that the cylinder lock is designed to scan at least one surface code on the end face of the flat key.

19. The cylinder lock according to claim 18, comprising an optionally multi-component coupling assembly rotatable about the axis of rotation and a locking nose, characterised in that the cylinder lock, preferably the coupling assembly, is designed to transmit a rotation of the cylinder core to the locking nose upon insertion of an authorised flat key.

20. The cylinder lock according to claim 19, wherein the coupling assembly is designed for positive engagement in the surface codes and optionally also in the additional codes on the end face of the flat key.

21. The cylinder lock according to claim 18, wherein an adapter is provided between the cylinder core and the coupling assembly, which adapter is displaceable substantially along, or parallel to, the axis of rotation, the adapter having a contour on the side facing away from the key channel for engagement in the coupling assembly.

22. The cylinder lock according to claim 21, wherein the adapter has at least one scanning element for engagement with the surface code, the surface shape of the scanning element preferably corresponding to the scanning surface of the surface code.

23. The cylinder lock according to claim 22, wherein the adapter has a plurality of scanning elements for engaging in the surface codes and, optionally, additional codes on the end face of the flat key, the surface shape of the scanning elements preferably corresponding to the scanning surfaces of the surface codes and, optionally, of the additional codes.

24. A locking system, comprising the flat key and one or more cylinder locks according to claim 18.
